(19) United States
(12) Patent Application Publication
(10) Pub. No.: US 2017/0171353 A1
(43) Pub. Date: Jun. 15, 2017

(54) APPARATUS AND METHOD FOR PROVIDING SERVICE USING INTERNET OF THINGS

(71) Applicant: ELECTRONICS AND TELECOMMUNICATIONS RESEARCH INSTITUTE, Daejeon (KR)

(72) Inventors: Noh-Sam PARK, Daejeon (KR); Hoon-Ki LEE, Daejeon (KR); Jong-Hyun JANG, Sejong-si (KR)

(21) Appl. No.: 15/364,434

(22) Filed: Nov. 30, 2016

(30) Foreign Application Priority Data
Dec. 10, 2015 (KR) 10-2015-0176122

(51) Int. Cl. H04L 29/08

(52) U.S. Cl. CPC H04L 67/327; H04L 67/2842

(57) ABSTRACT

A method for providing a service using the Internet of Things by a service providing apparatus includes generating conceptual thing information or things group information, or both the conceptual thing information and the things group information, corresponding to one or more things information stored in a things repository; generating an application using the conceptual thing information or the things group information or both the conceptual thing information and the things group information; and providing a service, by executing the application, for performing a function of a thing corresponding to at least one of the conceptual thing information and the things group information.

### CROSS-REFERENCE TO RELATED APPLICATION(S)

This application claims the benefit of Korean Patent Application No. 10-2015-0176122, filed with the Korean Intellectual Property Office on Dec. 10, 2015, the disclosure of which is incorporated herein by reference in its entirety.

### BACKGROUND

1. Field of the Invention

The present invention relates to providing a service using the internet of things.

2. Description of Related Art

The Internet of Things (IoT) is a technology that allows a user to control things that are capable of being connected to the Internet and is use in various areas, such as smart homes and smart factories.

With the expanded use of the IoT, the number of things being connected with the IoT has been exponentially increased. Accordingly, there is an increased need for a service and a system for efficiently controlling and managing these things.

The conventional IoT services provide a simple control service for each individual thing and thus have not been able to provide a user-friendly customized curation service using the user-required attributes only. Moreover, in an environment such as a smart school, a smart office or a smart factory, where a simultaneous control is required for things having same attributes, the conventional IoT services have to control the things individually, rather than controlling a group of things.

### SUMMARY

The present invention provides an apparatus and a method for providing an IoT service through a conceptual thing in which attributes of individual things are combined.

Moreover, the present invention also provides an apparatus and a method for providing an IoT service through a group of things in which same kinds of things are configured.

According to an aspect of the present invention, there is provided a service providing apparatus including: a conceptual things generating unit configured to generate conceptual thing information including at least some of function information included in one or more things information stored in a things repository; and an application providing unit configured to generate an application providing a service through the function information included in the conceptual thing information.

The conceptual things generating unit may search for one or more things information stored in the things repository in response to a user input requesting for search of the things information, receive a user input selecting one or more function information included in the things information, and generate the conceptual thing information including function information selected in response to the user input.

The conceptual things generating unit may register the conceptual thing information in the things repository or in a local repository.

The application providing unit may receive an input of a condition for performing a function of a thing corresponding to each of the function information included in the conceptual thing information, generate an event handler requesting for execution of the function of the thing in accordance with the function information corresponding to the condition, if an event satisfying the condition is occurred, and generate the application including the event handler.

According to another aspect of the present invention, there is provided a service providing apparatus including: a groups of things generating unit configured for generating things group information including at least some of a same kind of things information stored in a things repository, and an application providing unit configured for generating an application for providing a service performing a function of every one of things corresponding to each of the things information included in the things group information, if a predetermined condition is satisfied.

The groups of things generating unit may search for one or more things information stored in the things repository in response to a user input requesting for search of the same kind of things information, receive a user input selecting one or more of the searched things information, and generate the things group information including the things information selected in response to the user input.

The groups of things generating unit may register the things group information in the things repository or in a local repository.

The application providing unit may receive an input of the condition from a user, generate an event handler requesting for execution of the function of every one of the things corresponding to the things group information, if an event satisfying the condition is occurred, and generate the application including the event handler.

According to yet another aspect of the present invention, there is provided a method for providing a service using the Internet of Things by a service providing apparatus that includes: generating conceptual thing information or things group information, or both the conceptual thing information and the things group information, corresponding to one or more things information stored in a things repository; generating an application using the conceptual thing information or the things group information or both the conceptual thing information and the things group information; and providing a service, by executing the application, for performing a function of a thing corresponding to at least one of the conceptual thing information and the things group information.

The generating of the conceptual thing information or the things group information, or both the conceptual thing information and the things group information, corresponding to one or more things information stored in the things repository, may include: searching for one or more things information stored in the things repository in response to a user input requesting for search of the things information; if a user input is received selecting one or more function information included in the searched things information as a function of a conceptual thing, generating the conceptual thing information including function information selected according to the user input; and if a user input is received selecting one or more of the searched things information, generating the things group information including things information selected in response to the user input.

The generating of the conceptual thing information or the things group information, or both the conceptual thing information and the things group information, corresponding to one or more things information stored in the things repository, may further include: registering the conceptual thing information or the things group information, or both the conceptual thing information and the things group information, in the things repository or in a local repository.

The generating of the application using at least one of the conceptual thing information and the things group information may include: if a first condition is received for performing a function of a thing corresponding to each of the function information included in the conceptual thing information, generating an event handler requesting for execution of the function of the thing according to the function information corresponding to the condition when an event satisfying the first condition is occurred, and generating the application including the event handler, and if a second condition is received for performing a function of every one of things corresponding to the things group information, generating an event handler requesting for execution of the function of every one of the things corresponding to the things group information, and generating the application including the event handler.

According to an embodiment of the present invention, by providing an IoT service through conceptual things having only user-required attributes of things included therein, it is possible to control the access to the things in units of attributes and to provide the security and privacy for each thing.

According to an embodiment of the present invention, by providing an IoT service through groups of things, it is possible to collectively control the same kinds of things.

### BRIEF DESCRIPTION OF DRAWINGS

FIG. 1 is a block diagram illustrating a service providing apparatus in accordance with an embodiment of the present invention.

FIG. 2 illustrates conceptual things used for providing a service by the service providing apparatus in accordance with an embodiment of the present invention.

FIG. 3 illustrates groups of things used for providing a service by the service providing apparatus in accordance with an embodiment of the present invention.

FIG. 4 is a flow diagram illustrating how the service providing apparatus in accordance with an embodiment of the present invention provides a service through the conceptual things and the groups of things.

FIG. 5 is a flow diagram illustrating how the service providing apparatus in accordance with an embodiment of the present invention generates and registers conceptual thing information.

FIG. 6 is a flow diagram illustrating how the service providing apparatus in accordance with an embodiment of the present invention generates and registers things group information.

FIG. 7 illustrates a computer system in which the service providing apparatus in accordance with an embodiment of the present invention is realized.

### DETAILED DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the ideas and scope of the present invention.

Throughout the description of the present invention, when describing a certain relevant conventional technology is determined to evade the point of the present invention, the pertinent detailed description will be omitted. Moreover, all numerals (e.g., first, second, etc.) used in the description of the present invention are merely used to distinguish one element from another.

When one element is described as being “connected” or “accessed” to another element, it shall be construed that the one element may be directly connected or accessed to the other element, but it shall be also construed that, unless otherwise described, the one element may be connected or accessed to the other element via yet another element.

Hereinafter, some embodiments will be described in detail with reference to the accompanying drawings. Identical or corresponding elements will be given the same reference numerals, regardless of the figure number, and any redundant description of the identical or corresponding elements will not be repeated.

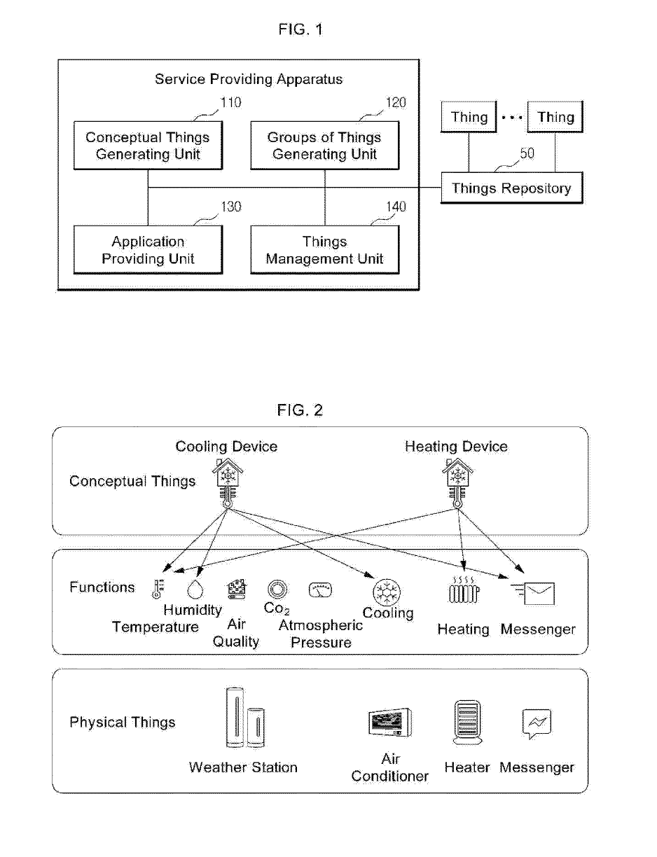

FIG. 1 is a block diagram illustrating a service providing apparatus in accordance with an embodiment of the present invention.

Referring to FIG. 1, the service providing apparatus in accordance with an embodiment of the present invention includes a conceptual things generating unit 110, a groups of things generating unit 120, an application providing unit 130 and a things management unit 140.

Here, the conceptual things generating unit 110, the groups of things generating unit 120, the application providing unit 130 and the things management unit 140 may be connected with a things repository 50 through a communication network to search for and obtain things information stored in the things repository 50. Moreover, the things information may include at least one kind of function information that is a method required for performing functions of things. For example, the things information of a weather station, which is a device for providing temperature information, humidity information, carbon dioxide information and atmospheric pressure information, may include function information for obtaining the temperature information, function information for obtaining the humidity information, function information for obtaining the carbon dioxide information and function information for obtaining the atmospheric pressure information. Here, the things repository 50 may be a repository configured according to a publicly available standard, such as one M2M, or configured in its own way. Moreover, the things may be each connected to the things repository 50 through a publicly available communication protocol. When the things repository 50 receives a request for search of things information from the conceptual things generating unit 110 and the groups of things generating unit 120, the things repository 50 may only provide things information corresponding to user-controllable things to the conceptual things generating unit 110 and the groups of things generating unit 120.

The conceptual things generating unit 110 searches for at least one of things information stored in the things repository 50 and generates conceptual thing information, in which at least some of function information included in each things information are combined. Here, in response to an input by a user requesting for search of a particular thing, the conceptual things generating unit 110 may search for thing information corresponding to the particular thing stored in the things repository 50 and provide the searched thing information to the user, and provide a user interface for allowing the user to select function information within the searched thing information. Accordingly, the user may receive the user interface through a display device and an input device equipped in a terminal or the service providing apparatus and searches the thing information, and input a selection for the function information within the thing information. The conceptual things generating unit 110 stores the generated conceptual thing information in the things repository 50 or in a local repository realized through a storage medium provided in the service providing apparatus.

For example, the things information and the conceptual thing information stored in the things repository 50 may be as shown in the below Table 1.

TABLE 1

| Thing | Type | Function Information |
|---|---|---|
| AC | Physical | setPower, setDuration, setMode, |
| | | setIntensity |
| Weather | Physical | getIndoorTemperature/Humidity/ |
| Station | | AirPressure/CO2/NoiseLevel |
| | | getOutdoorTemperature/Humidity |
| Heater | Physical | setPower, setDuration, setIntensity |
| Messenger | Physical | setRecipient, setMessage |
| ColdController | Conceptual | getIndoorTemperature, |
| | | getIndoorHumidity, setRecipient, |
| | | setMessage |

The groups of things generating unit 120 searches for same kinds of things information stored in the things repository 50 and generates things group information corresponding to a group of things including the same kind of things. Here, the things group information may include a method for collectively controlling functions of the things included in the things group. Here, in response to an input by the user requesting for search of a particular kind of things, the groups of things generating unit 120 may search for things information corresponding to the particular kind of things stored in the things repository 50 and provide the searched things information to the user, and provide a user interface for allowing the user to configure at least one of the searched things information as the group of things. The groups of things generating unit 120 may store the generated things group information in the things repository 50 or in the local repository.

The application providing unit 130 generates an application providing a service through at least one of the conceptual thing information, the things group information and the things information stored in the things repository 50. For example, when a particular condition is met, the application providing unit 130 may configure an event handler, which allows one or more functions of the conceptual thing information, the things group information and the things information stored in the things repository 50 to be performed, according to a user input. Specifically, the application providing unit 130 may receive a predetermined format of user input, such as “when [condition] then [function],” and configure the event handler for performing the corresponding function according to the user input. The application providing unit 130 generates and executes the application including the event handler generated through the afore-described steps.

The things management unit 140 updates or deletes at least one of the things information, the conceptual thing information and the things group information stored in the things repository 50 or the local repository, according to a user input requesting for update or deletion of the at least one of the things information, the conceptual thing information and the things group information.

FIG. 2 illustrates conceptual things used for providing a service by the service providing apparatus in accordance with an embodiment of the present invention.

Referring to FIG. 2, a weather station, an air conditioner, a heater and a messenger, which are physical things, perform one or more functions. Particularly, the weather station may carry out a plurality of functions of generating and providing temperature information, humidity information, carbon dioxide information and atmospheric pressure information. Here, the service providing apparatus may generate a conceptual thing of “cooling device” by combining functions of generating the temperature information and the humidity information, functions of the air conditioner and functions of the messenger. That is, the service providing apparatus may use the conceptual thing “cooling device” to measure a temperature and a humidity, operate the air conditioner according to the temperature and the humidity, and transmit a message to a user terminal to notify that the air conditioner is being operated. In other words, the service providing apparatus may provide services that would otherwise have been provided through a plurality of things through the single conceptual thing “cooling device.”

In another example, the service providing apparatus may generate a conceptual thing of “heating device” by combining the function of generating the temperature information, functions of the heater and functions of the messenger. Accordingly, the service providing apparatus may provide services of measuring the temperature, heating and sending a message through the conceptual thing “heating device.”

Therefore, by configuring the application through the conceptual thing information, the user may be provided with services using various function included in the “cooling device” or “heating device” even if the user is not aware of the physical things provided by the conceptual things.

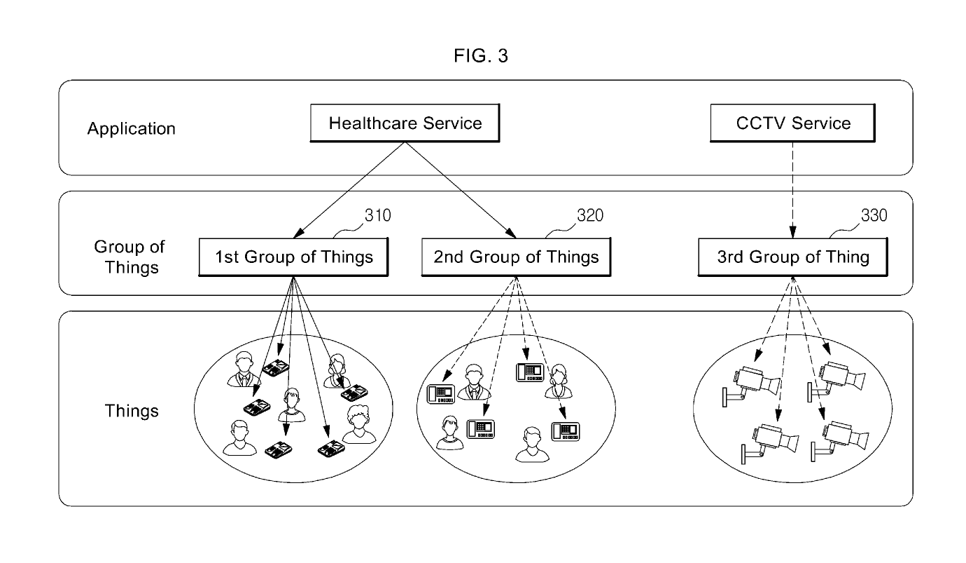

FIG. 3 illustrates groups of things used for providing a service by the service providing apparatus in accordance with an embodiment of the present invention.

Smart factories, healthcare, security control and transportation/logistics are often serviced using same kinds of things. Conventionally, in order to perform a similar or same function provided by the same kinds of things, it has been inconveniently required that an event hander be configured for each of the things implemented in these services. For example, the healthcare service may involve sending a message to a hospital if hypertension or hypotension is measured through blood pressure measuring things possessed by users. For this, the conventional system for providing an IoT service is required to configure an event handler for every single thing that measures the blood pressure of patients.

Referring to FIG. 3, in the service providing apparatus in accordance with an embodiment of the present invention, by configuring a group of things with some of the things measuring the blood pressure and by providing an application through the group of things, a healthcare service may be provided through each thing by configuring an event handler for each group of things.

For example, the service providing apparatus may generate a first group of things 310, which includes blood pressure measuring things belonging to a first group of patients for whom doctors need to be notified when the blood pressure reading is 120 mmHg or higher, and a second group of things 320, which includes blood pressure measuring things belonging to a second group of patients for whom doctors need to be notified when the blood pressure reading is 150 mmHg or higher. Here, the service providing apparatus may provide a service of sending a message about a risky blood pressure status of each patient to a hospital, by configuring an event handler for the first group of things 310 and an event handler for the second group of things 320.

In another example, the service providing apparatus may provide a CCTV service for a particular high-crime area, by generating a third group of thins 330, which includes every CCTV camera located in the particular high-crime area, and configuring an event handler for the third group of things 330.

Therefore, in the service providing apparatus in accordance with an embodiment of the present invention, it is possible to generate a group of things that includes same kinds of things and provide a service using the functions of the things included in the group of thins by configuring a single event handler for the group of things.

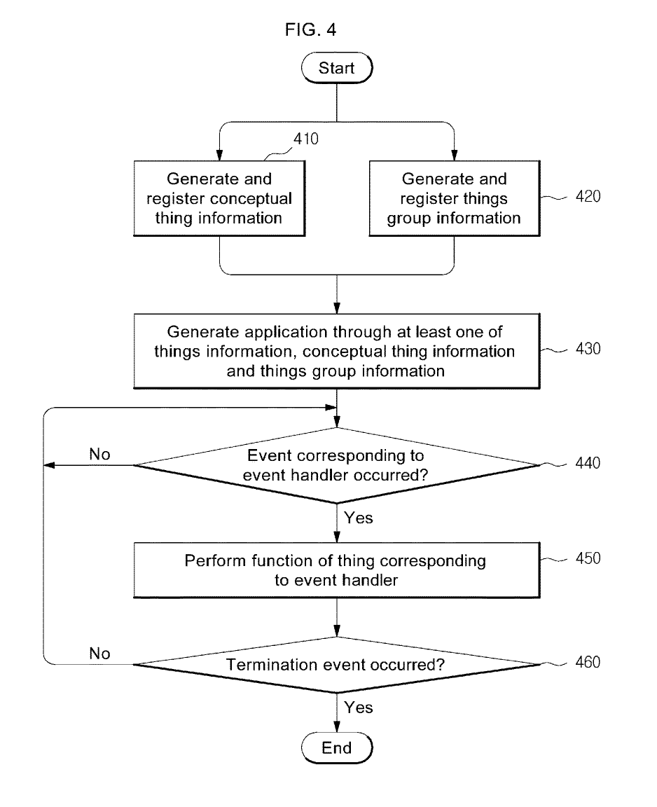

FIG. 4 is a flow diagram illustrating how the service providing apparatus in accordance with an embodiment of the present invention provides a service through the conceptual things and the groups of things.

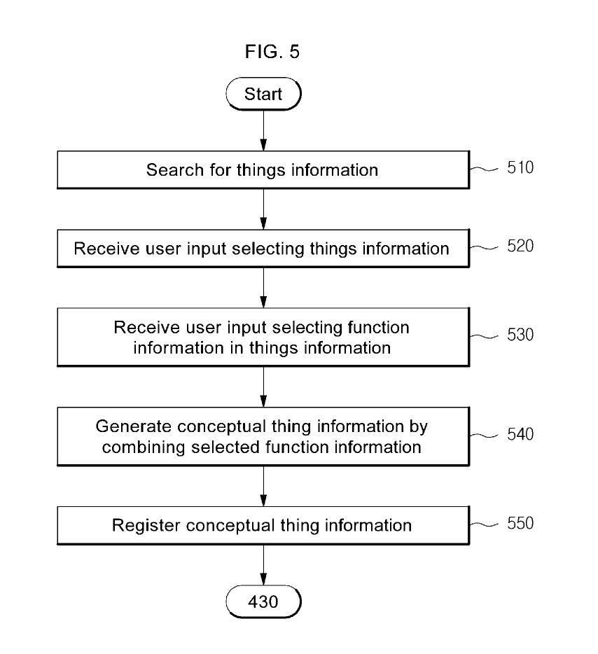

Referring to FIG. 4, in step 410, the service providing apparatus generates and registers conceptual thing information. The process of generating and registering the conceptual thing information will be described later in detail with reference to FIG. 5.

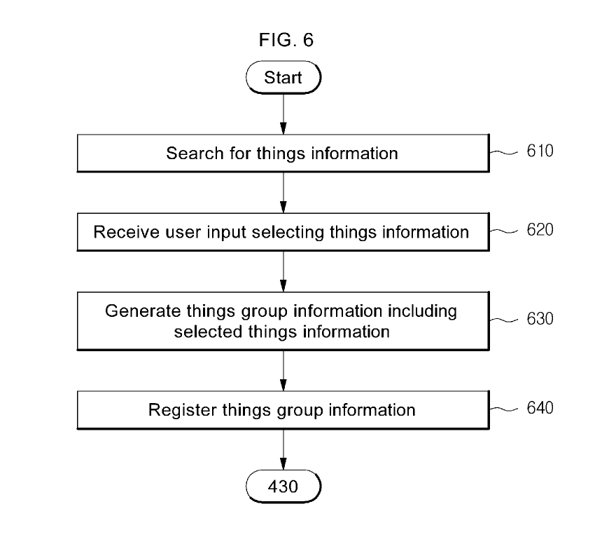

In step 420, the service providing apparatus generates and registers things group information. The processes of generating and registering the things group information will be described later in detail with reference to FIG. 6. Moreover, one of the step 410 and the step 420 may be skipped if necessary. For instance, if there is no need for a group of things, the service providing apparatus may perform step 410 only.

In step 430, the service providing apparatus generates an application through the conceptual thing information or the things group information stored in the things repository 50 or local repository, or through both the conceptual thing information and the things group information. For instance, the service providing apparatus may receive an input from the user configuring an event handler corresponding to function information of the things information, the conceptual thing information and the things group information and then generate an application including the event handler. Moreover, the application may be configured to be terminated when an event meets a predetermined condition, for example, when a function of a particular thing is performed. For the convenience of description, the event mentioned above will be referred to as a “termination event” hereinafter.

In step 440, the service providing apparatus determines whether an event corresponding to the event hander of the application has occurred.

If it is determined in the step 440 that no event corresponding to the event handler has occurred, the service providing apparatus repeats the step 440.

If it is determined in the step 440 that an event corresponding to the event handler has occurred, the service providing apparatus performs, in step 450, a function of the thing corresponding to the event handler.

In step 460, the service providing apparatus determines whether the termination event has occurred.

If it is determined in the step 460 that the termination event has not occurred, the service providing apparatus repeats the step 440.

If it is determined in the step 460 that the termination event has occurred, the service providing apparatus terminates the service.

FIG. 5 is a flow diagram illustrating how the service providing apparatus in accordance with an embodiment of the present invention generates and registers conceptual thing information.

Referring to FIG. 5, in step 510, pursuant to a user input requesting for search of a particular thing, the service providing apparatus searches for things information stored in the things repository 50.

In step 520, the service providing apparatus receives a user input selecting at least one of the searched things information.

In step 530, the service providing apparatus receives a user inform selecting function information in the things information.

In step 540, the service providing apparatus generates conceptual thing information by combining the function information selected in the step 530.

In step 550, the service providing apparatus registers the conceptual thing information in the things repository 50 or in a local repository within the service providing apparatus.

FIG. 6 is a flow diagram illustrating how the service providing apparatus in accordance with an embodiment of the present invention generates and registers things group information.

Referring to FIG. 6, in step 610, pursuant to a user input requesting for search of same kinds of things, the service providing apparatus searches for things information stored in the things repository 50.

In step 620, the service providing apparatus receives a user input selecting at least one of the searched things information.

In step 630, the service providing apparatus generates things group information including the selected things information.

In step 640, the service providing apparatus registers the things group information in the things repository 50 or in the local repository.

The service providing apparatus in accordance with an embodiment of the present invention described above may be realized in a computer system.

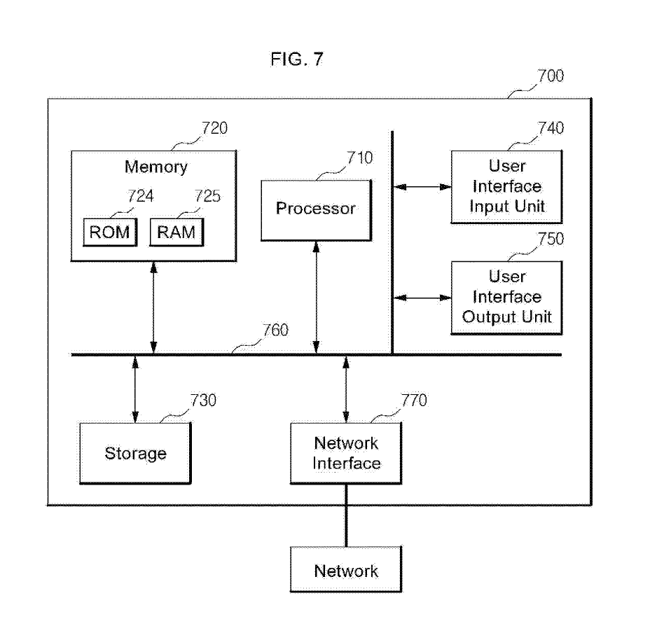

FIG. 7 illustrates a computer system in which the service providing apparatus in accordance with an embodiment of the present invention is realized.

An embodiment of the present invention may be realized in a computer system, for example, as a computer-readable recording medium. As illustrated in FIG. 7, a computer system 700 may include at least one of elements consisting of a processor 710, a memory 720, a storage 730, a user interface input unit 740 and a user interface output unit 750, which are communicable with one another through a bus 760. Moreover, the computer system 700 may further include a network interface 770 for accessing a network. The processor 710 may be a CPU or a semiconductor device for running process instructions stored in the memory 720 and/or storage 730. The memory 720 and the storage 730 may include various types of volatile/non-volatile memory media. For example, the memory 720 may include ROM 724 and RAM 725.

Hitherto, certain embodiments of the present invention have been described, and it shall be appreciated that a large number of permutations and modifications of the present invention are possible without departing from the intrinsic features of the present invention by those who are ordinarily skilled in the art to which the present invention pertains. Accordingly, the disclosed embodiments of the present invention shall be appreciated in illustrative perspectives, rather than in restrictive perspectives, and the scope of the technical ideas of the present invention shall not be restricted by the disclosed embodiments. The scope of protection of the present invention shall be interpreted through the claims appended below, and any and all equivalent technical ideas shall be interpreted to be included in the claims of the present invention.

What is claimed is:

1. A service providing apparatus comprising:
a conceptual things generating unit configured to generate conceptual thing information including at least some of function information included in one or more things information stored in a things repository; and
an application providing unit configured to generate an application providing a service through the function information included in the conceptual thing information.

2. The service providing apparatus of claim 1, the conceptual things generating unit is characterized by:
searching for one or more things information stored in the things repository in response to a user input requesting for search of the things information;
receiving a user input selecting one or more function information included in the things information; and
generating the conceptual thing information including function information selected in response to the user input.

3. The service providing apparatus of claim 2, wherein the conceptual things generating unit is characterized by registering the conceptual thing information in the things repository or in a local repository.

4. The service providing apparatus of claim 1, wherein the application providing unit is characterized by:
receiving an input of a condition for performing a function of a thing corresponding to each of the function information included in the conceptual thing information;
generating an event handler requesting for execution of the function of the thing in accordance with the function information corresponding to the condition, if an event satisfying the condition is occurred;
generating the application including the event handler.

5. A service providing apparatus comprising:
a groups of things generating unit configured for generating things group information including at least some of a same kind of things information stored in a things repository; and
an application providing unit configured for generating an application for providing a service performing a function of every one of things corresponding to each of the things information included in the things group information, if a predetermined condition is satisfied.

6. The service providing apparatus of claim 5, wherein the groups of things generating unit is characterized by:
searching for one or more things information stored in the things repository in response to a user input requesting for search of the same kind of things information;
receiving a user input selecting one or more of the searched things information; and
generating the things group information including the things information selected in response to the user input.

7. The service providing apparatus of claim 6, wherein the groups of things generating unit is characterized by registering the things group information in the things repository or in a local repository.

8. The service providing apparatus of claim 5, wherein the application providing unit is characterized by:
receiving an input of the condition from a user,
generating an event handler requesting for execution of the function of every one of the things corresponding to the things group information, if an event satisfying the condition is occurred;
generating the application including the event handler.

9. A method for providing a service using the Internet of Things, the service being provided by a service providing apparatus, the method comprising:
generating conceptual thing information or things group information, or both the conceptual thing information and the things group information, corresponding to one or more things information stored in a things repository;
generating an application using the conceptual thing information or the things group information or both the conceptual thing information and the things group information; and
providing a service, by executing the application, for performing a function of a thing corresponding to at least one of the conceptual thing information and the things group information.

10. The method of claim 9, wherein the generating of the conceptual thing information or the things group information, or both the conceptual thing information and the things group information, corresponding to one or more things information stored in the things repository, comprises:
searching for one or more things information stored in the things repository in response to a user input requesting for search of the things information;
if a user input is received selecting one or more function information included in the searched things information as a function of a conceptual thing, generating the conceptual thing information including function information selected according to the user input; and
if a user input is received selecting one or more of the searched things information, generating the things group information including things information selected in response to the user input.

11. The method of claim 10, wherein the generating of the conceptual thing information or the things group information, or both the conceptual thing information and the things group information, corresponding to one or more things information stored in the things repository, further comprises:
registering the conceptual thing information or the things group information, or both the conceptual thing information and the things group information, in the things repository or in a local repository.

12. The method of claim 9, wherein the generating of the application using at least one of the conceptual thing information and the things group information comprises:
if a first condition is received for performing a function of a thing corresponding to each of the function information included in the conceptual thing information, generating an event handler requesting for execution of the function of the thing according to the function information corresponding to the condition when an event satisfying the first condition is occurred, and generating the application including the event handler; and
if a second condition is received for performing a function of every one of things corresponding to the things group information, generating an event handler requesting for execution of the function of every one of the things corresponding to the things group information, and generating the application including the event handler.
